(19) United States
(12) Patent Application Publication
(10) Pub. No.: US 2004/0099511 A1
(43) Pub. Date: May 27, 2004

(54) Rolling conveyor guide rail

(75) Inventors: Germanus J.P.M. Nas, Oostrum (NL); Johannes S.T.M. Gubbels, Sambeek (NL); Hubertus P.P.J. Vervoort, Venlo (NL); Henricus P.M.J. Pingen, Maashees (NL)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/304,184

(22) Filed: Nov. 25, 2002

(51) Int. Cl. B65G 39/18

(52) U.S. Cl. 198/836.1

(57) ABSTRACT

A conveyor having a conveyor surface has along the lateral edges rotating guide elements. The rotating guide elements rotate on axes of rotation that lie in a plane that is substantially perpendicular to the conveyor surface, and also in a plane that is substantially perpendicular to the path of the conveyor. Each guide element has an outer circumferential surface that engages the lateral sides of a conveyed article on the conveyor surface to rotate the guide element, substantially eliminating sliding or rubbing contact between the conveyed article and the lateral guide elements.

### BACKGROUND

The present invention relates to guiding conveyed articles along a conveyor path, such as in a manufacturing, sorting, storage, or shipping setting.

Conveyors are used in many settings to move articles along a path from one location to another. A typical conveyor includes a conveyor surface upon which the conveyed articles are placed. Guide rails are often used on the lateral perimeters of the conveyor surface. The guide rails guide the conveyed article as it moves along the path. The guide rails prevent the conveyed article from falling off the conveyor surface, and in some circumstances guide the conveyed article to a precision position for action by a person or piece of equipment. As it moves along the path on the conveyor surface, the conveyed article rubs against the lateral guide rails.

Conveyors are sometimes used in environments that are very sensitive to the presence of airborne particles. For example, a “clean room” used for semiconductor manufacturing or for certain chemical coating operations requires that airborne particles be minimized because even small particles can cause substantial defects in the article being manufactured or coated. The conveyed article may be a pallet carrying the article being manufactured or coated. As the conveyed article, such as the pallet, rubs against the guide rails to be guided as it is conveyed along the path, the friction created can release airborne particles that may cause problems in such a clean room environment.

### SUMMARY

A conveyor includes a conveyor surface upon which conveyed articles can be placed. The conveyor also includes rotating guide elements adjacent at least one lateral side of the conveyor surface. Each rotating guide element has an outer surface with a perimeter portion that intersects a plane that is substantially perpendicular to the conveyor surface at exactly one point. In examples, each rotating guide element is a cylinder or a sphere axially centered on an axis of rotation that is substantially perpendicular to the conveyor surface.

### FIGURES

FIG. 1 is a perspective view of a conveyor incorporating one embodiment of an aspect of the present invention.

FIG. 2 is a perspective view of a conveyor incorporating another embodiment of an aspect of the present invention.

FIG. 3 is a perspective view of a conveyor incorporating one embodiment of guide elements.

FIG. 4 is a cross sectional view of a portion of the conveyor of FIG. 3, taken along line 4-4 of FIG. 3.

FIG. 5 is a cross sectional view of a portion of a conveyor incorporating another embodiment of guide elements.

FIG. 6 is a cross sectional view of a portion of a conveyor incorporating yet another embodiment of guide elements.

FIG. 7 is a perspective view of a conveyor incorporating another embodiment of guide elements.

FIG. 8 is a cross sectional view of a portion of the conveyor of FIG. 7, taken along line 8-8 of FIG. 7.

FIG. 9 is a cross sectional view of a portion of a conveyor incorporating another embodiment of guide elements.

### DETAILED DESCRIPTION

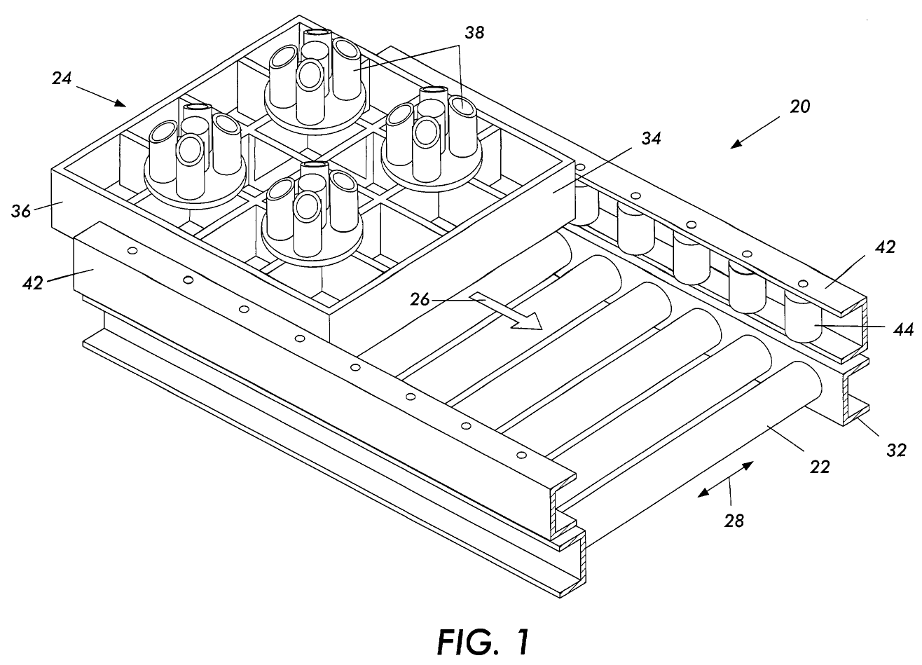

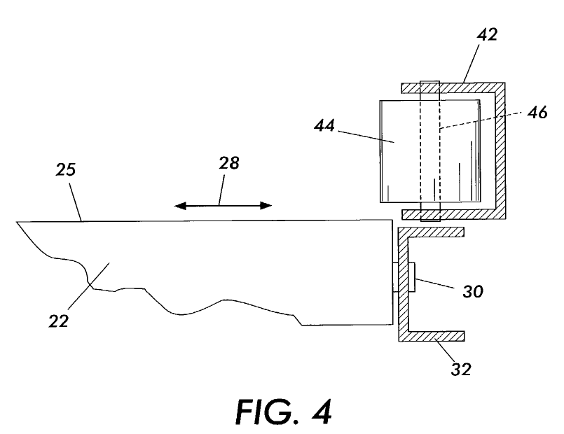

FIG. 1 shows a segment of a conveyor 20 formed of a plurality of elongate, cylindrical surface rollers 22 forming a conveyor surface 25 (see FIG. 4) upon which a conveyed article 24 is placed. The conveyor has a longitudinal direction, forming a path 26 along which the conveyed article 24 moves. The conveyor has a lateral direction 28 substantially perpendicular to the longitudinal direction. Each conveyor surface roller 22 has a central axis of rotation 30 (see FIG. 4). In an implementation, the ends of each surface roller are attached to lateral frame elements 32 of the conveyor. The axis of rotation of each surface roller 22 is aligned with the lateral direction 28 at that point along the conveyor. In one implementation, the conveyor surface rollers 22 rotate freely about their axes of rotation 30 to provide a low friction conveyor surface. In other implementations, one or more of the conveyor surface rollers may be powered to rotate in a particular direction to convey a moving force to the conveyed article 24 as the circumferential surface of the powered roller engages the underside of the conveyed article.

In the particular implementation illustrated, the conveyor surface rollers have substantially horizontal axes of rotation 30 that are substantially parallel one another. However, those familiar with conveyors will recognize that the conveyor surface can be angled laterally by arranging the axes of rotation at an angle, or longitudinally by arranging the rollers so that the rollers have successively higher elevations along at least a segment of the conveyor. In addition, a series of adjacent conveyor surface rollers can be arranged with the surface rollers closer to one another at one end of each roller than they are at the other end, to provide a bend or curve in the conveyor path.

The particular conveyed article 24 shown includes a pallet for carrying an article to be processed. The pallet shown in FIG. 1 is rectangular, with a bottom surface (not visible) that rests on the conveyor surface, end sides 34 and lateral sides 36, and has a structure 38 for holding a photoreceptor belt to be coated for use in a xerographic or electrostatic printing device. The end sides 34 and lateral sides 36 of the pallet are substantially perpendicular to the bottom surface of the pallet. However, any of numerous other shapes of pallets may be conveyed. In addition, the conveyed article may be an article itself, placed upon the conveyor surface without a pallet.

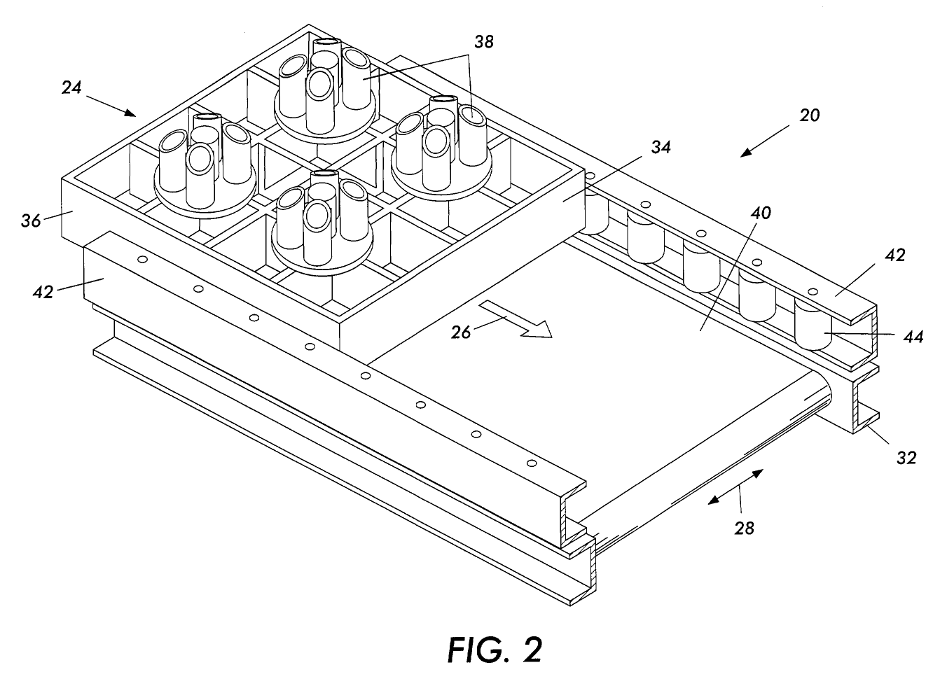

FIG. 2 shows a segment of another conveyor implementation in which a belt or web 40 forms the conveyor surface. Many of the elements of the conveyor shown in FIG. 2 are the same as the conveyor of FIG. 1, so the same reference numerals are used. Those skilled in the art will recognize that different structures can be used to hold the belt 40, including a series of rollers (not visible, but substantially similar to the rollers 22 shown in FIG. 1) upon which the conveyor belt rests. In many applications, at least one of the rollers supporting the conveyor belt is powered to rotate so that as the powered roller engages the underside of the conveyor belt, it moves the conveyor belt along the conveyor path 26. In the conveyor belt implementation, the conveyed article rests upon the conveyor belt. Frictional contact between the surface of the conveyor belt and the bottom surface of the conveyed article causes the conveyed article to move with the conveyor belt along the conveyor path 26.

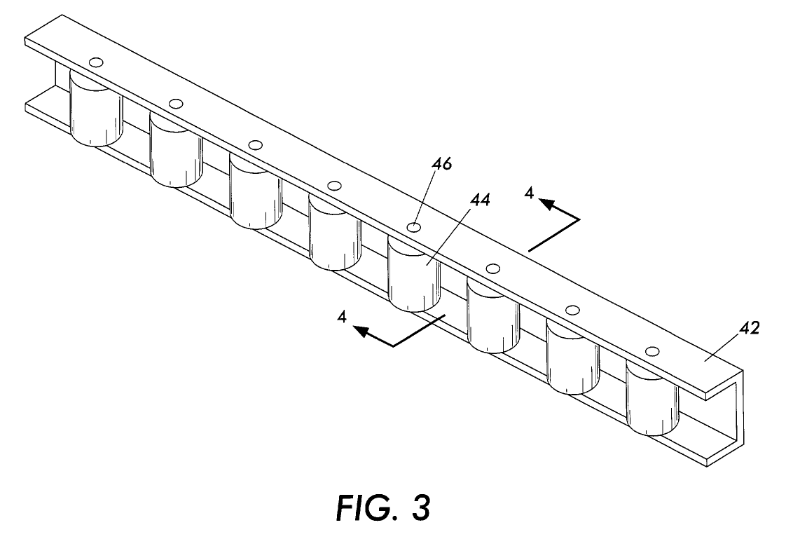

Along at least one of the lateral sides of the conveyor is a lateral guide frame 42 holding a plurality of rotating guide elements. In particular implementations, a guide frame 42 extends along both the left and right lateral sides of the conveyor surface, and each guide frame holds a plurality of rotating guide elements 44. The lateral guide frame 42 and rotating guide elements 44 are shown in greater detail in FIGS. 3 and 4. Although FIG. 4 shows the conveyor surface 25 as formed of the outer surface of the conveyor surface rollers 22 of the implementation of FIG. 1, the conveyor surface can also be the upper surface of the conveyor belt 40 of the implementation of FIG. 2. Each guide element 44 in the illustrated embodiment is a cylinder that rotates about a guide element axis of rotation 46. The axis of rotation 46 of each rotating guide element 44 lies in a plane that is perpendicular to the conveyor surface 25. Preferably, each plane containing the axis of rotation of a rotating guide element is oriented in the lateral direction 28 of the conveyor. The axes of rotation of the rotating guide elements are substantially parallel one another, and are substantially perpendicular to the adjacent segment of the conveyor surface 25. Consequently, the outer (or circumferential) surface of the cylindrical guide element is also substantially perpendicular to the adjacent conveyor surface. The circumferential surface of the cylindrical guide element is substantially circular. This configuration permits the outer surface of the guide element to closely match the lateral side surface 36 of the pallet being conveyed on the conveyor.

The illustrated conveyor includes rotating guide elements 44 on both lateral sides of the conveyor. However, such rotating guide elements may be included on only one side of the conveyor, as for example along the lower lateral side of a laterally angled conveyor surface.

Preferably, each guide element 44 rotates freely about its guide element axis of rotation 46, with very low friction. Thus, as the pallet moves along the conveyor past each rotating guide element, contact between the lateral sides of the pallet and the circumferential surface of each guide element causes the circumferential surface of the rotating guide element to frictionally engage the lateral sides of the pallet. The rotating guide element rotates about its guide element axis of rotation 46 so that the circumferential surface of the rotating guide element moves with the lateral side 36 of the pallet, with is little or no sliding or rubbing between the rotating guide element and the lateral side of the pallet. With little or no rubbing contact between the guide element and the pallet, the guide element and the pallet surfaces release few if any particles into the environment surrounding the conveyor. The rotating guide elements are formed of a hard material that resists the breaking off of surface particles. For example, stainless steel, a plastic, or a rigid material such as Teflon can be used to form the rotating guide elements. In other implementations, the rotating guide elements can be formed of a soft deformable material to provide cushioned guidance for a conveyed article on the conveyor. The rotation of the guide elements minimizes rubbing between the conveyed articles and the lateral guide elements, thus minimizing or eliminating the breaking off of particles from the surfaces of the guide elements.

In certain applications the conveyor may be designed to use some of the lateral guide elements 44 to supply motive force to the conveyed article 24 (such as the pallet). For example, a motor may power some of the lateral guide elements 44 to rotate at a predetermined speed. As a lateral side 36 of the pallet comes into contact with the circumferential surface of such a powered guide element, the contact between the guide element and the pallet transfers a motive force to the pallet.

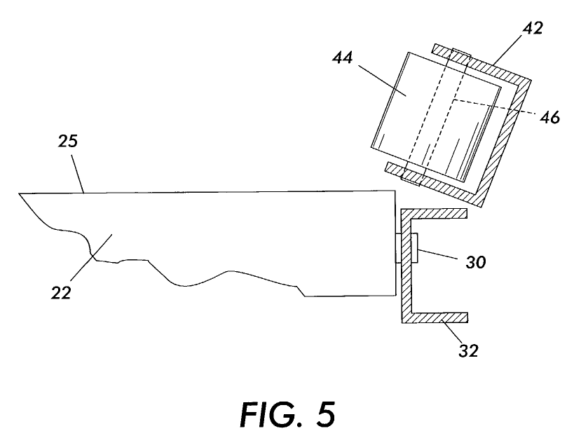

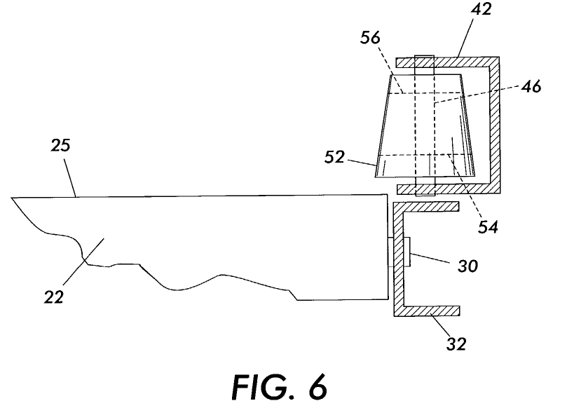

After reading the present descriptions, those skilled in the art will recognize that the guide elements 44 can be angled at an angle other than perpendicular with respect to the conveyor surface 25. Such angled rotating guide elements may be beneficial in a conveyor designed to convey articles having lateral sides that are not perpendicular to the bottom. As illustrated in FIG. 5, such an angled guide element may include a cylindrical guide element 48 having an axis of rotation 50 that is angled with respect to the conveyor surface 25 at an angle other than perpendicular. The lateral guide frame 42 may also be angled as illustrated, or it may be perpendicular to the conveyor surface, with the guide element axis of rotation 50 angled with respect to the lateral guide frame. In an alternative illustrated in FIG. 6, the angled guide element may include a non-cylindrical rotating guide element 52 having an axis of rotation 46 that is substantially perpendicular to the conveyor surface. The non-cylindrical rotating guide element 52 has one cross-section 54 on a plane substantially perpendicular to the axis of rotation that is larger than a cross-section 56 on a different plane that is also substantially perpendicular to the axis of rotation. For example, the non-cylindrical rotating guide element 52 may have a conical or frusto-conical shape.

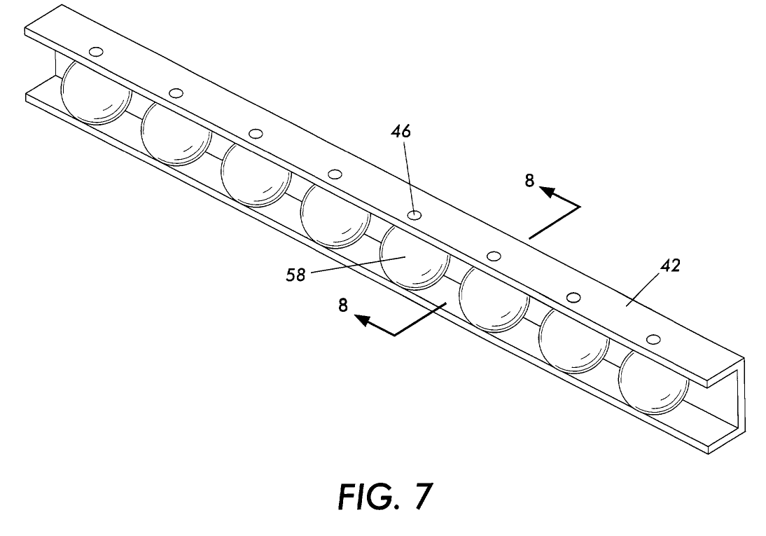

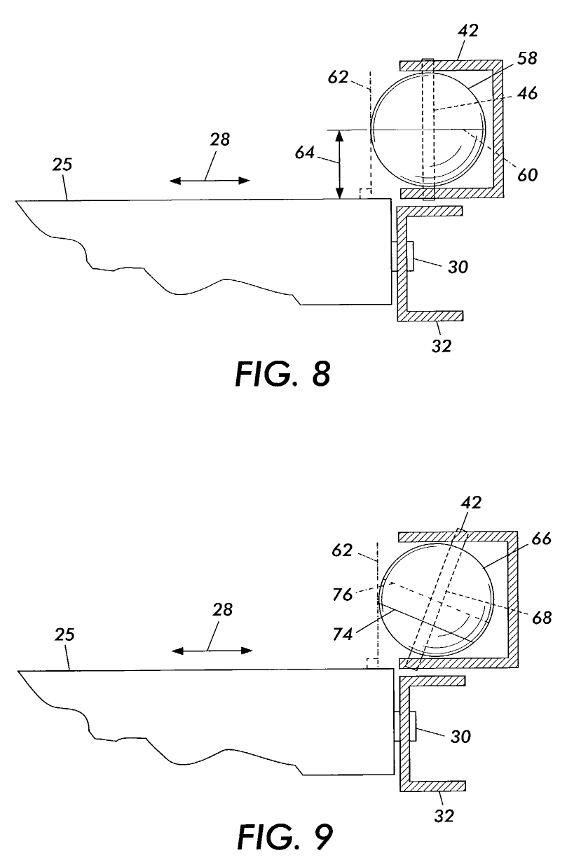

FIGS. 7 and 8 show rotating guide elements 58 that are spherical, rather than cylindrical. The axis of rotation 46 is substantially perpendicular to the conveyor surface 25. A circumferential portion 60 of the outer surface of the rotating guide element intersects a conveyor vertical plane 62 that is substantially perpendicular to the conveyor surface 25. The circumferential portion 60 intersects the conveyor vertical plane 62 a predetermined distance 64 above the conveyor surface. As a conveyed article having lateral sides that are substantially perpendicular to the article bottom (such as the conveyed article 24 shown in FIGS. 1 and 2) passes along the conveyor, the lateral side of the conveyed article may coincide with the conveyor vertical plane 62. Thus, as the conveyed article passes the rotating guide element 58, the circumferential portion 60 of the outer surface of the guide element engages the lateral side of the conveyed article. The circumferential portion 60 of the spherical guide element having an axis of rotation perpendicular to the conveyor surface is at the equator of the guide element. In applications in which the conveyor surface 25 is not horizontal, the conveyor vertical plane 62 that is perpendicular to the conveyor surface is not strictly vertical. However, the “vertical plane” terminology will be used to describe the plane perpendicular to the conveyor surface 25, even when not strictly vertical.

FIG. 9 shows a rotating guide element 66 having an axis of rotation 68 that is angled with respect to the conveyor surface 25 at an angle other than perpendicular. The implementation illustrated in FIG. 9 illustrates a feature of all the implementations. As each rotating guide element rotates about its central axis of rotation, a circumferential portion of the outer surface of the rotating guide element intersects a conveyor vertical plane 62 that is substantially perpendicular to the conveyor surface 25. In particular, a point on that circumferential portion of the rotating guide element intersects the conveyor vertical plane only once during a complete rotation of the rotating guide element.

FIG. 9 illustrates a spherical rotating guide element 66 in which a circumferential portion 74 of the outer surface of the guide element intersects the conveyor vertical plane 62 that is substantially perpendicular to the conveyor surface. That circumferential portion 74 of the outer surface is on a rotational plane that is substantially perpendicular to the axis of rotation 68 of the guide element. With the axis of rotation angled with respect to the conveyor surface at an angle other than perpendicular, this rotational plane is away from the equator 76 of the sphere. If the axis of rotation is perpendicular to the conveyor surface, this rotational plane passes through the equator of the sphere, so that the circumferential portion of the outer surface is the equator of the rotating guide element, as seen in FIG. 8.

A few implementations of the present invention have been described above. After studying the above, those skilled in the art will recognize that a variety of modifications can be made to the particular implementations described. For example, numerous other shapes of rotating guide elements can be used to implement the invention. Those skilled in the art will also recognize that other mechanisms for attaching the rotating guide elements to the conveyor frame can be used. In addition, the guide elements can be attached to the conveyor in different manners, and different types of conveyor mechanisms can benefit from the present invention. For certain applications, the guide elements can be arranged and oriented so that the circumferential portions of the outer surface engage a conveyed article along a plane that is not perpendicular to the conveyor surface. Therefore, the invention is not limited to the details of the particular described implementations.

We claim:

1. A conveyor comprising:
a conveyor surface upon which conveyed articles can be placed;
a plurality of rotating guide elements along at least one lateral side of the conveyor surface, wherein:
each guide element has a guide element axis of rotation;
the guide element axis of rotation of each guide element lies in a plane that is substantially perpendicular to an adjacent segment of the conveyor surface.

2. The conveyor of claim 1, wherein:
the conveyor surface has a longitudinal direction along which the conveyed articles are conveyed;
the conveyor surface has a lateral direction substantially perpendicular to the longitudinal direction; and
the guide element axis of rotation of each guide element lies in a plane that is substantially aligned with the lateral direction of an adjacent segment of the conveyor surface.

3. The conveyor of claim 2, wherein the guide element axis of rotation for each guide element is substantially perpendicular to an adjacent segment of the conveyor surface.

4. The conveyor of claim 1, wherein each guide element has a substantially circular circumference around the guide element axis of rotation.

5. The conveyor of claim 4, wherein each guide element is a cylinder centered on the guide element axis of rotation.

6. The conveyor of claim 4, wherein each guide element is a sphere centered on the guide element axis of rotation.

7. The conveyor of claim 1, wherein the conveyance surface comprises a plurality of rollers, each having a substantially horizontal axis of rotation.

8. The conveyor of claim 1, wherein the conveyor surface comprises a belt.

9. A conveyor comprising:
a conveyance surface upon which conveyed articles can be placed;
a rotating guide element adjacent a lateral side of the conveyance surface, wherein:
the rotating guide element has an outer surface;
as the rotating guide element rotates, a circumferential portion of the outer surface intersects a plane that is substantially perpendicular to the conveyance surface.

10. The conveyor of claim 9, wherein a point on the circumferential portion of the outer surface intersects the plane only once during a complete rotation of the rotating guide element.

11. The conveyor of claim 9, wherein:
the rotating guide element rotates about an axis of rotation;
the circumferential portion of the rotating guide element has a diameter substantially perpendicular to the axis of rotation;
the axis of rotation of the rotating guide element is substantially perpendicular to the conveyance surface;
the circumferential portion of the rotating guide element has the largest diameter of the rotating guide element;
the rotating guide element is substantially cylindrical; and
the rotating guide element is substantially spherical.

12. A conveyor comprising:
a substantially horizontal conveyance surface for receiving conveyed articles and facilitating the movement of the conveyed articles along a path;
a right lateral guide frame structure adjacent the opposite side of the conveyance surface and extending along at least a portion of the path;
a left lateral guide frame structure adjacent one side of the conveyance surface and extending along at least a portion of the path;
a plurality of right rotational guide elements attached to the right lateral guide frame structure, wherein:
each right rotational guide element rotates about a substantially vertical axis of rotation;
each right rotational guide element is attached to the right lateral guide frame structure through the axis of rotation;
each right rotational guide element has a substantially circular perimeter centered on the axis of rotation; and
each right rotational guide element freely rotates on its axis of rotation; and
a plurality of left rotational guide elements attached to the left lateral guide frame structure, wherein:
each left rotational guide element rotates about a substantially vertical axis of rotation;
each left rotational guide element is attached to the left lateral guide frame structure through the axis of rotation;
each left rotational guide element has a substantially circular perimeter centered on the axis of rotation; and
each left rotational guide element freely rotates on its axis of rotation.

13. The conveyor of claim 12, wherein:
each right rotational guide element is a cylinder; and
each right rotational guide element is a cylinder.

14. The conveyor of claim 12, wherein:
each left rotational guide element is a sphere; and
each left rotational guide element is a sphere.
